(19) United States
(12) Patent Application Publication
(10) Pub. No.: US 2007/0192345 A1
(43) Pub. Date: Aug. 16, 2007

(54) Method of assessing consumer preference tendencies based on an analysis of correlated communal information

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,972

(22) Filed: Jan. 29, 2007

Related U.S. Application Data
(60) Provisional application No. 60/762,514, filed on Jan. 27, 2006.

(51) Int. Cl. G06F 7/00

(52) U.S. Cl. 707/100

(57) ABSTRACT

A method of providing users with improvements in the acquisition of data and the presentation of the acquired data is provided in respect of users searching for a good or service. The method exploits the storing of other users consumer-history data for a plurality of different users within databases distributed across the World Wide Web, the user consumer-history data relating to the good, service, and an opinion that is associated, at least temporarily, with that user. The other users consumer-history data is correlated with the users own consumer-history to identify matches, within predetermined thresholds, of the same or other goods and services. These identified matches are presented to the user allowing their review and decision making. Advantageously the highly correlated data obtained from the other users, ranging from tens to millions, can be represented to the user in a three dimensional visualization enhancing their comprehension of the results and ability to make selections.

This application claims the benefit of U.S. Provisional Application 60/762,514, filed on Jan. 27, 2006, the entire contents of which are incorporated herein by reference.

### FIELD OF THE INVENTION

The present invention relates to data searching, and more particularly to a method of assessing consumer preference tendencies based on an analysis of correlated communal information.

### BACKGROUND

Data storage, analysis, retrieval and display have always been important aspects of computers. Although different data retrieval and data display models have been proposed over the years, one of three models are typically employed today due to their programming simplicity, relative ease of use, and perceived user comprehensibility. These three models are typically referred to as the desktop model, the list based model, and the hierarchical list model. These models have persevered despite the dramatically increased processing capabilities of computers and the large capacity of the human brain to process visual information.

The issue of perceived user comprehensibility arises as users are extremely familiar with simple list based models and as a result, users when assessing techniques tend to rate lists highly. However, with the rapid expansion of i) the use of computers within a diverse range of consumer products, such as MP3 players, cellular telephones and PDAs, and ii) the amount of information that is accessible via the Internet, or World Wide Web, on these and other devices, a user is presented with many lists, from many different websites and of many different formats. For example, a standard 80 Gb iPod™ holds approximately 20,000 songs, a large list to work with. Even assuming 10 songs per album, and having an average of 4 albums per artist yields lists of either 2,000 albums or 500 artists. Accessing the website of a major online retailer and searching for Gothic novels, perhaps not an obviously popular genre, leads to displaying potentially over 3,000 books for sale and over 3,100 books in the genre having customer reviews. The website provides this list typically as an HTML formatted web page, displayed for viewing on the users computer.

Now consider the same user going to the websites of three other commercial booksellers, from which they obtain another four web pages, each containing thousands of book entries, with many repetitions. If the user owns several hundred Gothic novels already and is seeking to purchase another, ideally within a sub-genre they have been enjoying recently, then it is clear that this user must expend significant effort to select a new novel to purchase, unless they simply buy a current new bestseller from a favorite booksellers recent release section.

Even, restricting themselves to customer reviews, especially those which provide percentage scores, is fraught with limitations in current applications as the user typically will not know how many reviews were made, were the reviewers themselves the purchasers or were the books they reviewed gifts and not their normal reading material. Each user who has provided a review, has themselves a large amount of information, including but not limited to what they have previously purchased, previously reviewed, own from other sources, etc. At present this information does not enter in any aspect of the users search.

It would be advantageous to provide a method for analyzing this information to provide highly correlated data sets that overcome at least some of the above-mentioned limitations of the prior art.

As mentioned supra, current methods for visualizing such highly correlated sets of data do not produce results that are intuitive to the user, and as a result the analysis is cumbersome and prone to errors and the visualization is confusing and prone to omissions. It would therefore be advantageous to users with enhanced visualizations of these highly correlated data sets and improve the user's knowledge base for their decisions.

### SUMMARY OF EMBODIMENTS OF THE INSTANT INVENTION

According to an aspect of the instant invention there is provided a method comprising: storing first data for each one of a plurality of different users, first data for each user including data relating to at least one of a good, a service, a need, an ability, a responsibility, and an opinion that is associated with that user; correlating the first data of one user of the plurality of different users with the first data of other users of the plurality of different users to identify which of the other users have first data correlating with the one user's first data to within a predetermined threshold limit so as to define a group of correlated users; analyzing the first data of each user of the group of correlated users according to a known process, the known process for identifying a similarity in the first data, excluding similarities that match the one user's first data to within the predetermined threshold amount, the identified similarity in the first data indicative of one or more suggestions; and, providing an indication of at least the first data for presentation to the one user.

According to another embodiment of the invention there is provided a method of assessing preference tendencies, comprising: receiving first data that is associated with a first user; using a predetermined process, mapping the first data onto a data structure having stored therein other data associated with each one of a plurality of other users; correlating the first data with the other data to determine a group of other users selected from the plurality of other users, each user within the determined group of other users having first data associated therewith that matches the first data of the first user to within a predetermined threshold limit; correlating the first data of each user within the determined group of users so as to determine other matches within the group, the other matches relating to a portion of the first data that does not form a part of the first data of the first user, said portion of the first data other than relating to something personal to the first user; and, providing an indication of the other matches.

According to another aspect of the invention there is provided a computer-readable storage medium having stored thereon computer-executable instructions for performing a method of assessing consumer preference tendencies, the method comprising: storing first data for each one of a plurality of different users, first data for each user including data relating to at least one of a good, a service, a need, an ability, a responsibility, and an opinion that is associated with that user; correlating the first data of one user of the plurality of different users with the first data of other users of the plurality of different users to identify which of the other users have first data correlating with the one user's first data to within a predetermined threshold limit so as to define a group of correlated users; analyzing the first data of each user of the group of correlated users according to a known process, the known process for identifying a similarity in the first data, excluding similarities that match the one user's first data to within the predetermined threshold amount, the identified similarity in the first data indicative of one or more suggestions; and, providing an indication of at least the first data for presentation to the one user.

According to another embodiment of the invention there is provided a computer-readable storage medium having stored thereon computer-executable instructions for performing a method of assessing consumer preference tendencies, the method comprising: receiving first data that is associated with a first user; using a predetermined process, mapping the first data onto a data structure having stored therein other data associated with each one of a plurality of other users; correlating the first data with the other data to determine a group of other users selected from the plurality of other users, each user within the determined group of other users having first data associated therewith that matches the first data of the first user to within a predetermined threshold limit; correlating the first data of each user within the determined group of users so as to determine other matches within the group, the other matches relating to a portion of the first data that does not form a part of the first data of the first user, said portion of the first data other than relating to something personal to the first user; and, providing an indication of the other matches.

### BRIEF DESCRIPTION OF THE DRAWINGS

Exemplary embodiments of the invention will now be described in conjunction with the following drawings, in which similar reference numerals designate similar items:

FIG. 1 illustrates a typical webpage presented to a user searching for information on products matching a search criteria they have entered into an Internet search engine or retailer search database;

FIG. 2 illustrates further elements of the typical webpage of FIG. 1 presented to a user searching highlighting activities by other customers accessing this product according to the prior art;

FIG. 3 illustrates a typical prior art search result from a commercial retailer in wishing to find Gothic novels, listed based upon “bestselling” status as established by the commercial retailer;

FIG. 4 illustrates a typical prior art search result from a commercial retailer in wishing to find Gothic novels, listed based upon “average customer review” status as established by the commercial retailer from customer reviews submitted;

FIG. 5 illustrates a typical prior art search by a user in respect of finding a Gothic novel and being presented thereupon with multiple lists according to the commercial retailers or websites accessed;

FIG. 6 illustrates a first embodiment wherein a user is provided with options for purchasing further first products, established by correlating the users preferences and historical purchases of first products with other databases representing other user preferences of first products;

FIG. 7 illustrates a second embodiment of the invention wherein a user is provided with a 3D visualization of their products associated with a first product category, the 3D visualization established by correlating aspects of the users preferences and historical records for these products;

FIG. 8 illustrates a third embodiment of the invention wherein a user is provided with a 3D visualization of further first products, established by correlating the users preferences and historical purchases of first products with other databases representing other user preferences of first products; and,

FIG. 9 illustrates a fourth embodiment of the invention wherein a user is provided with a 3D visualization of second products, established by correlating the users preferences and historical purchases of first products with other databases representing other user preferences of first and second products.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

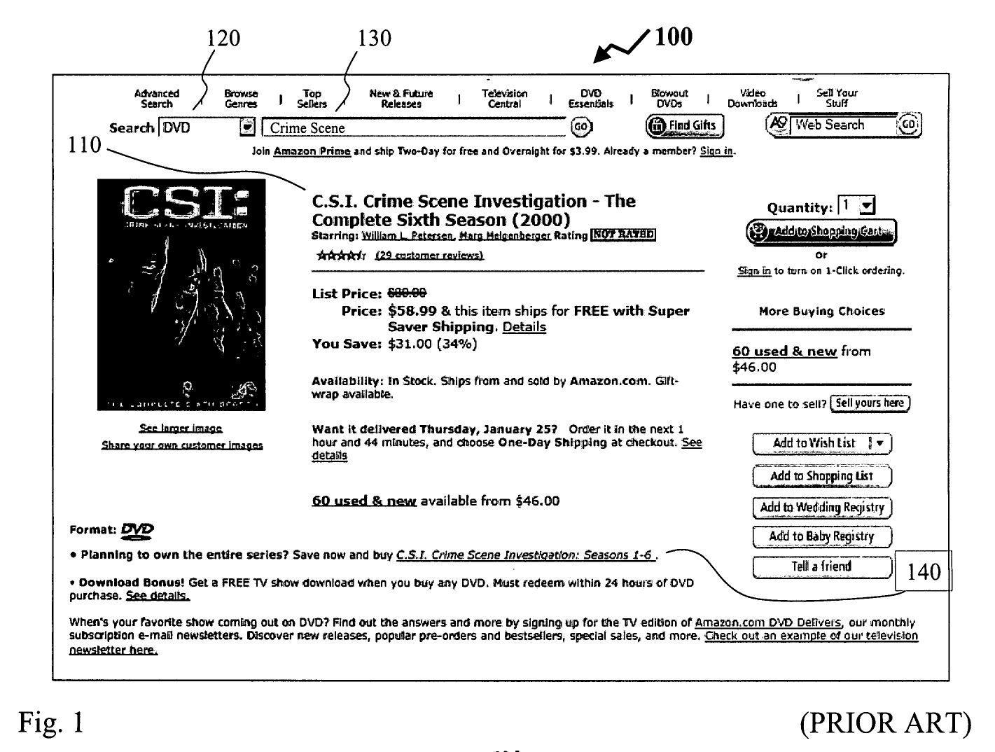

A typical product web page 100 of a commercial retailer is shown in FIG. 1, which is for instance provided in response to a web search being performed by a user according to the prior art. The user has previously selected the search category DVD by filling in a first field entry 120, and restricted the search further using a second field entry 130 “Crime Scene”. From the provided list of matched products (not shown for clarity), which is commonly referred to as “hits,” the user has selected one entry resulting in the detailed product webpage 100 being displayed. In this instance the user selected from the product title 110, “Crime Scene Investigation®—The Complete Sixth Season.”

Also displayed is a further product listing 140, which in this instance is for buying six entire series, and is therefore an “up selling” attempt by the commercial retailer that provided the website from which the product webpage 100 is provided.

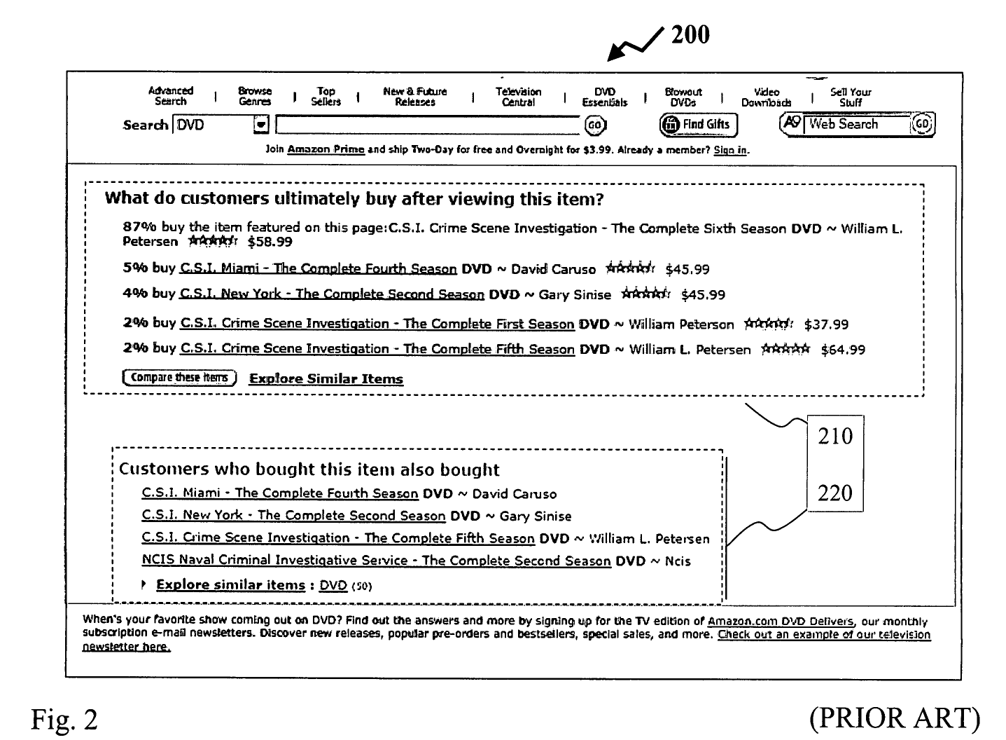

As part of the product webpage 100 provided, the retailer has added further information, accessed by scrolling down the product webpage 100, such that the second view 200 of the user as depicted within FIG. 2 is provided. As shown, two customer-orientated information fields 210 and 220 are displayed. The first customer orientated information field 210 provides the user with an analysis of actions that were taken by previous customers after viewing the product web page. Of the previous customers that ultimately made a purchase subsequent to viewing the product web page, 87% purchased the product title 110, “Crime Scene Investigation®—The Complete Sixth Season”, and the remaining 13% purchased one of the four other titles, either from the same television series “Crime Scene Investigation®,” or relating to two other associated series.

The second customer orientated information field 220 provides the user with an analysis of what customers who bought the product title 110 “Crime Scene Investigation—The Complete Sixth Season” also purchased. Such customer orientated information fields 210 and 220 are designed to encourage the user to purchase the product title 110 “Crime Scene Investigation—The Complete Sixth Season”, with very high statistics in the first customer orientated information field 210 of browsing viewers purchasing the product, and products in the second customer orientated information field 220 are all for sale on the commercial retailers website. Of course, the website is silent regarding the fraction of the previous customers that did not ultimately make a purchase.

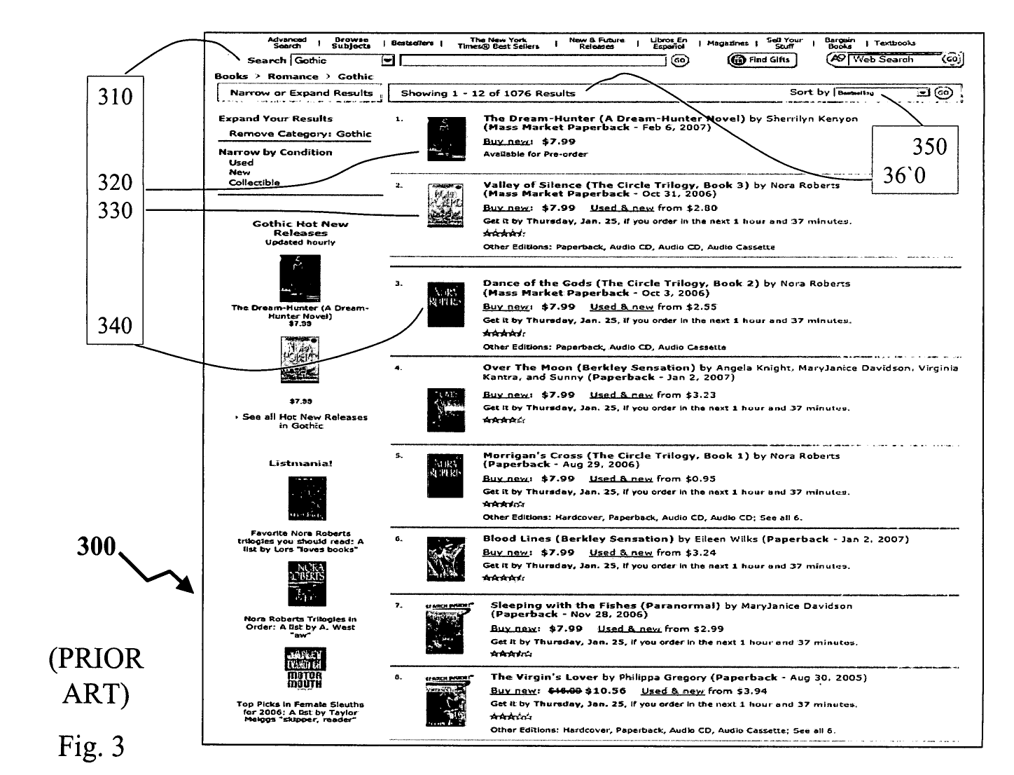

As discussed supra, the user initially accessed the product web page 100 by selecting one item from a list of results that was provided in response to a search query. An exemplary list according to the prior art is shown in FIG. 3. The displayed list webpage 300 having been generated in response to the user being within the romance book section of the commercial retailer's web site, as indicated by text 310 which also includes the search term narrowing the search “Gothic”.

The search has returned 1,076 results as shown in the results field 360, and that these were displayed in best selling order as denoted in sorting field 350. The top 8 books are displayed in the displayed list webpage 300, with the top result being “The Dream Hunter” 320, second being “Valley of Silence” 330, and third being “Dance of the Gods” 340, etc.

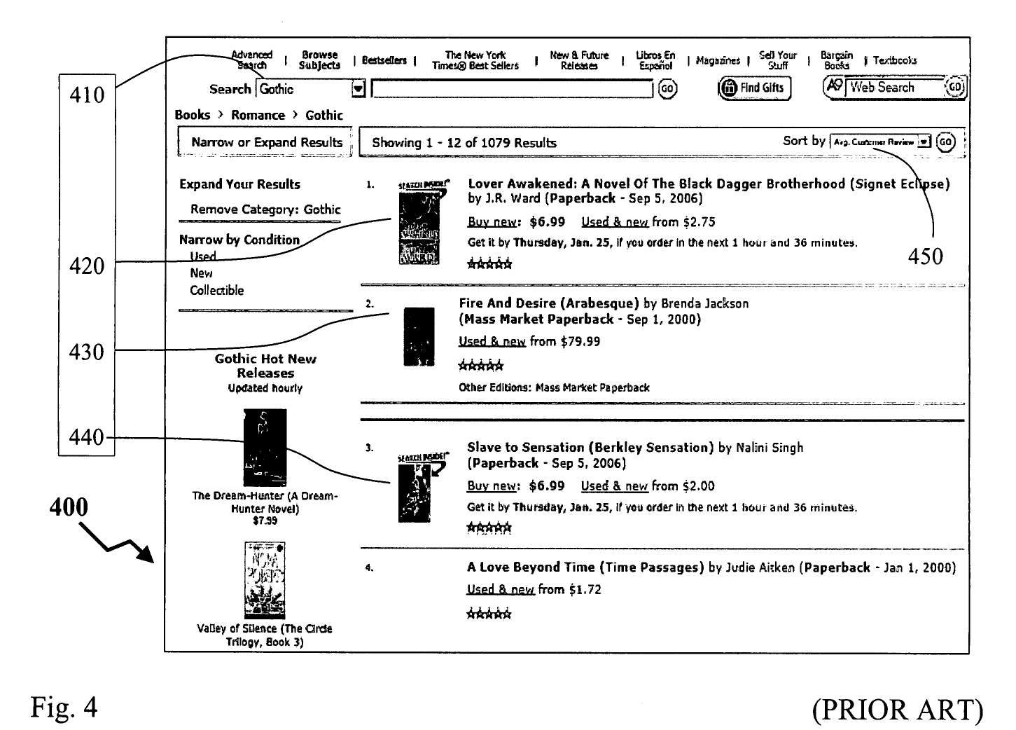

If the user now changes the sorting field from the previous “bestsellers” 350 to “Average Customer Review” 450 then the displayed webpage is represented as review webpage 400 as shown in FIG. 4. Now for the same search term “Gothic” 450 the top three books are “Lover Awakened” 420, the second is “Fire and Desire” 430, and the third is “Slave to Sensation” 440.

However, if the user were to now correlate the two web pages 300 and 400 they would find that the top book “Lover Awakened” 410 on the review webpage 400 is actually twelfth on the displayed list webpage 300, which is perhaps understandable if the other higher selling best sellers such as “The Dream Hunter” 320, “Valley of Silence” 330, and “Dance of the Gods” 340 were released after “Lover Awakened” 420 such that readers may not have finished these books and provided reviews.

The second ranked book on the review webpage 400, “Fire and Desire” 430 does not actually make the top 350 best sellers on the displayed list webpage 300. It would be apparent to one with knowledge in the art that such results indicate the poor correlation between information being presented to the user from current applications.

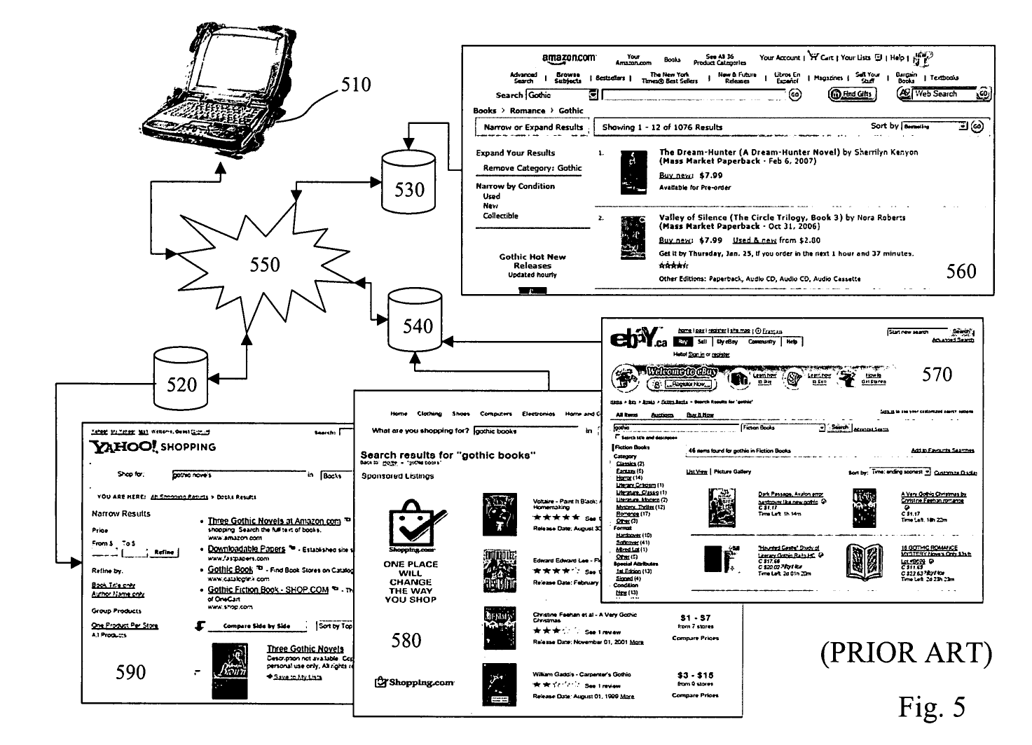

Now, the user seeking more information accesses multiple commercial retailers as displayed in reference to FIG. 5. Here the user is accessing from their personal computer 510 the World Wide Web 550 and accessing multiple retailers websites 560 through 590. Firstly, the user accesses Amazon™ through a first web host server 530 resulting in Amazon webpage 560 being presented to the user. Now the user accesses eBay™ through a second web host server 540 from which they extract an eBay webpage 570, thereby being provided with information in a different display format making correlation to the Amazon webpage 570 difficult and time consuming.

Next the user accesses the Shopping.com™ website from the second web host server 540 and obtains Shopping.com webpage 580. Finally, not yet finding what they have been seeking, the user accesses the Yahoo! Shopping website via a third web host server 520 and obtains the Yahoo webpage 590. Clearly, such searching using current software applications makes obtaining the desired information for the user difficult.

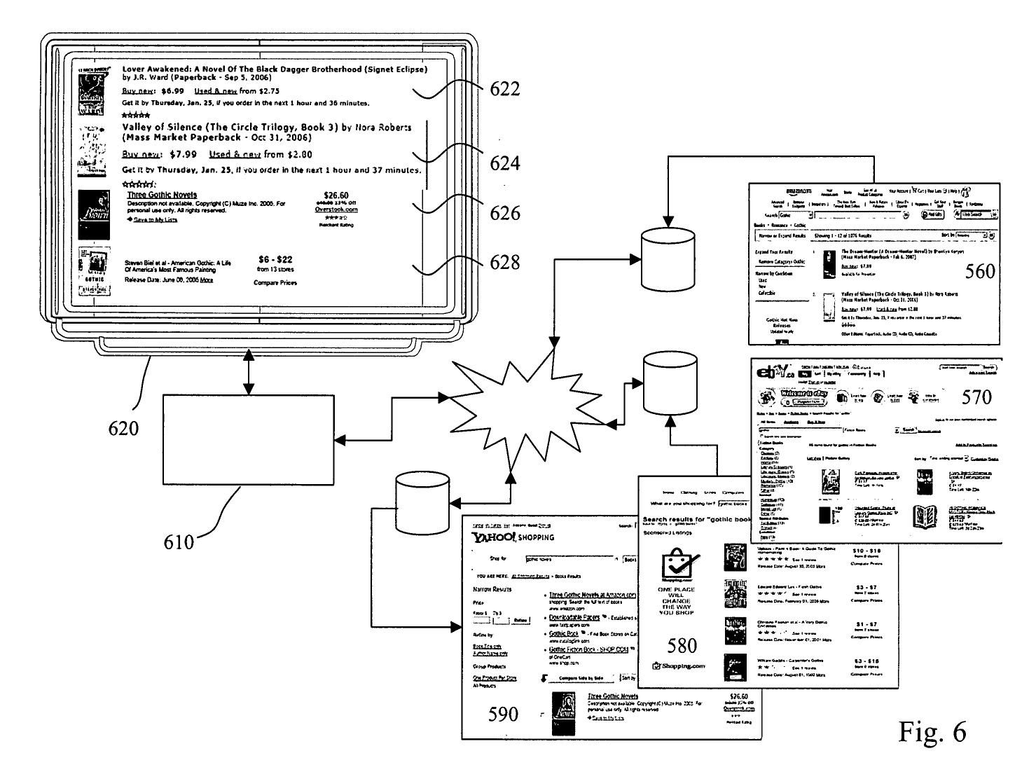

FIG. 6 outlines an exemplary alternative searching approach according to a first embodiment of the invention. As shown the user working at their computer 620 is performing a search for a Gothic novel. This search being undertaken using keywords entered by the user into a software application 610.

According to the keywords entered and the preferences stored within the software application 610 four commercial retailers websites are again accessed, each providing the software application 610 with the HTML formatted web pages Amazon webpage 560, eBay webpage 570, Shopping.com webpage 580, and Yahoo! Webpage 570. Based upon the information provided from the Amazon webpage 560, eBay webpage 570, Shopping.com webpage 580, and Yahoo! Webpage 570 the software application 610 provides a correlation of the information from these multiple sources and presents a correlated summary to the user on the display of their computer 620. As shown, four books are presented, “Lover Awakened” 622, “Valley of Silence” 624, “Three Gothic Novels” 626, and “American Gothic—The Life of America's Most Famous Painting” 626. As such the correlated summary differs significantly from the top four listing of any of the four individual websites, and some of the books such as “American Gothic” 628 and “Three Gothic Novels” 626 were low down the lists on two of the websites, and hence may not have been considered by the user previously with prior art search analysis.

The presentation of correlated data presented supra, in respect of FIG. 5, presents the information in a conventional list based model, as does for example, their media player, such as Windows Media Player™ or iTunes™. If a user has many books, documents, CDs, and DVDs, these are typically catalogued by different applications and, as such, correlations are generally limited to within a single genre of material, for example music. Hence a user employing iTunes™ will be able to hold their audio and visual (video) libraries within this database and perform searches as long as they know the artist, album or part of the title. However, for documents they will generally be employing a package such as Windows Explorer™, which provides folder listing and document listing, or another for their book titles etc such as personally developed database with Lotus Notes™ or Microsoft Excel™, for example.

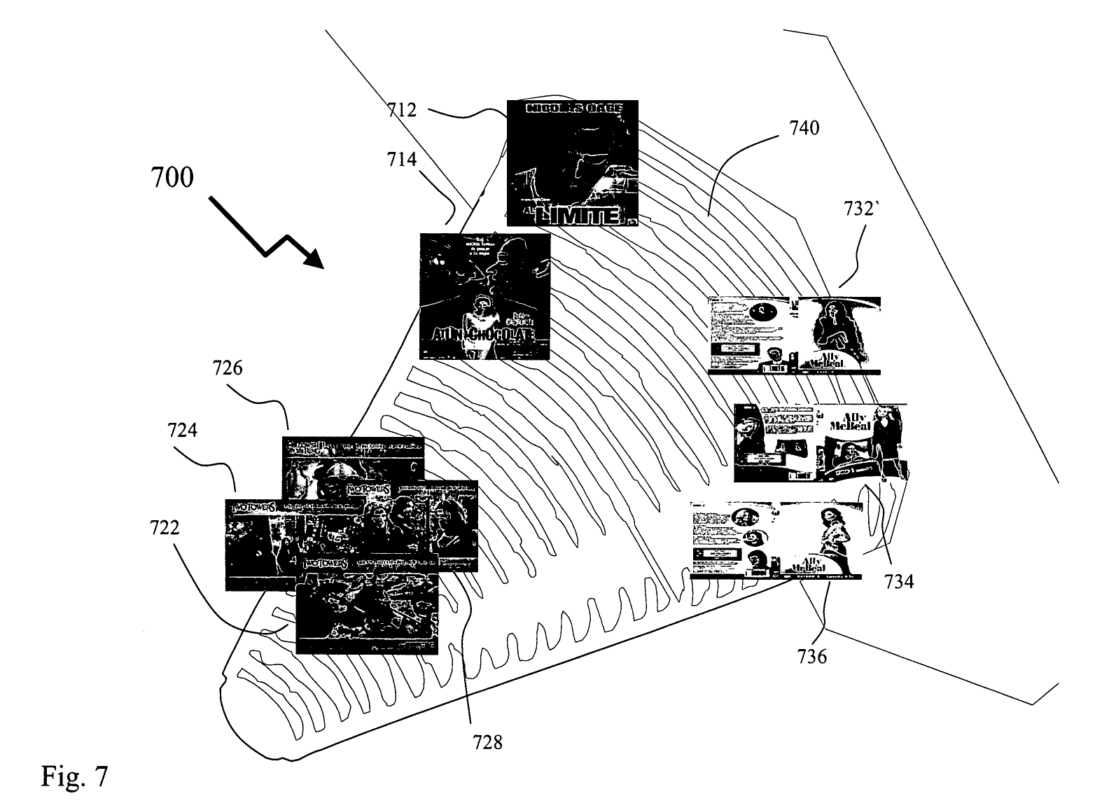

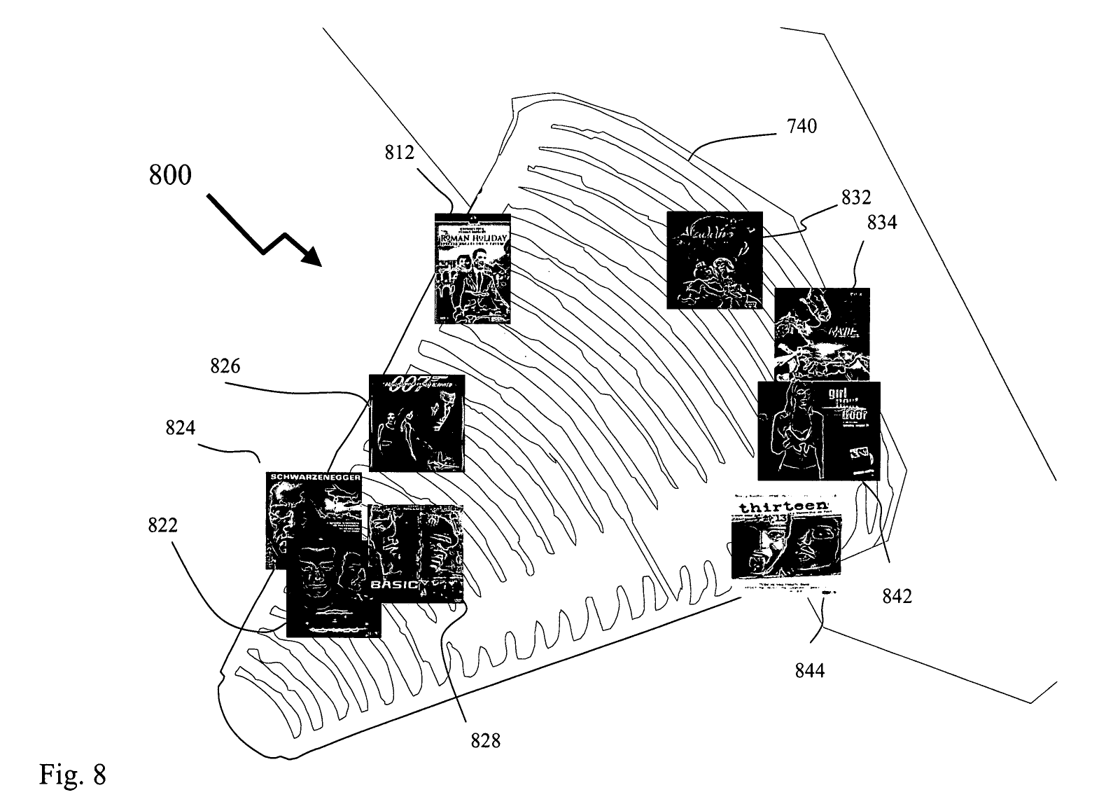

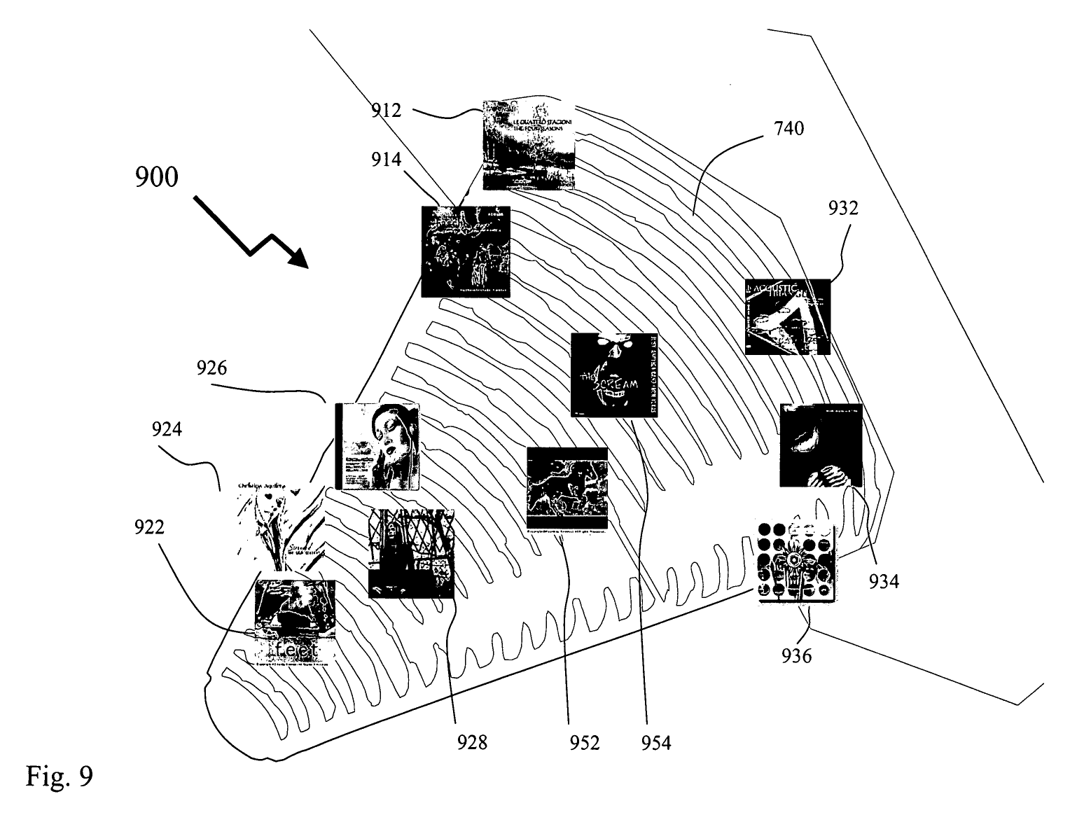

The current methods for visualizing even highly correlated sets of data do not produce results that are intuitive to the user, and as a result the analysis is cumbersome and prone to errors and the visualization is confusing and prone to omissions. An alternative approach is presented in respect of FIG. 7 according to an embodiment of the invention. Shown is a three dimensional visualization 700 of the DVD library of a user. The three dimensional visualization presents their library as icon images 712 to 714, 722 to 728, and 732 to 736 mapped to a three dimensional surface 740. Within the discussions relating to the three dimensional surface 740 this and FIGS. 8-9 all represent this three dimensional surface 740 as a cone. The actual three dimensional surface 740 that is chosen optionally is selected from a range of three dimensional shapes, including but not limited to a sphere, cube, cylinder, dodecahedron, etc. The selection of the appropriate surface is optionally under the direction of the user from a selection function within the software application, or it is predetermined by the software application as the basis of a default setting, or optionally based upon the highly correlated data to be mapped onto the surface.

As shown in FIG. 7, the user's video library is mapped onto the three-dimensional visualization 700 based upon genre. As such “Limite” 712 and “Chocolat” 714 are classified as “Foreign”. Placement of each genre onto the three dimensional surface 740 is determined, in this example, by a correlation application extracting the last viewed dates of all films within the genre and generating an average time since last viewed. Genre with long average times being presented near the rearward, wider portion of the cone compared to those more recently viewed genres being presented near the apex of the cone.

The user's video collection includes a second genre, “Independent Women”, which has been specified by the user into the correlation application. The correlation application has mapped “Ally McBeal Series 1” 732, “Ally McBeal Series 2” 734, and “Ally McBeal Series 3” 736 to the lower wider portion of the cone, again on the basis of long average times since last viewing. Also shown is a third genre, Action, represented by “The Fellowship of the Ring” 722, “The Tower Towers” 724, “Return of the King” 726, and “The Hobbit” 728. These by virtue of a low average time since last viewing are presented mapped onto the three dimensional surface 740 near the apex.

The display of genre and films optionally is provided in one of several alternative fashions. For instance, the genre and films are displayed using text titles, icon images defining the genre, icon images defining the genre or sub-genre, icon images representing a series of videos such as a single icon for “Star Wars” so to simply 6 elements (for instance) to one element, etc. Also the placement of the icons representing elements of the correlated data is determined according to one of several different rules, according to alternative embodiments of the invention. For example, the placement optionally is defined by the correlation of an element to other near datasets, such that a film within the genre “Foreign” but featuring a storyline about an “Independent Woman” is placed close to the boundary of these two genres. It may also be appropriate to display the positions along the surface of the cone, in this instance of the three dimensional surface, according to actual time since last viewing within the overall placement that is determined by last viewing. Hence, whilst “Foreign” has a high average time since last viewing “Chocolat” 714 was viewed more recently than “Limite” 712 and hence is placed closed to the apex of the cone.

Whilst the three dimensional visualization 700 presented to the user in respect of FIG. 7 is static, it is optionally a manipulatable or travesable visualization. Hence, whilst the data may be recalculated and redisplayed based upon a change within the criteria provided to the correlating application, the data may be displayed in summative form initially due to its quantity and then expanded upon as a result of the user “navigating” to that portion of the surface. For example, when mapping the results to a sphere the display includes only genre titles around most of the surface of the sphere, except for the genre that is currently facing the user, which is expanded in some way by virtue of being the “currently selected genre for viewing.” Rotating the sphere, or equivalently changing the user viewpoint, results in some elements of the visualization reducing in detail and others expanding in detail. Optionally, the mapping displays a portion of the information for an item, such as artist name, until that region is expanded by the user at which point the title is presented, or initially data is presented in chronological windows and detail only is shown upon selecting one chronological window.

Whilst such a three dimensional visualization of the highly correlated data of an individual is beneficial and advantageous over the prior art, it would be evident that the approach enables the correlation of multiple data sources with enhanced user comprehensibility. Such an example is shown below in respect of FIG. 8 for an “Also Like” display 800 resulting from a users web search of multiple commercial retailers websites. Hence, as discussed supra in respect of FIG. 6 the application extracts data from a plurality of networked databases in response to a query, and performs a correlation based upon the results returned. In this example, the user has requested options for purchasing a new video that is within one of their existing genres.

The correlation application in extracting and correlating the initial datasets has filtered these based upon parameters established in respect of the users own database data. In this example, the data being presented is videos having high customer ratings from customers of the plurality of commercial retailers who bought videos matching those within the users database. As can already be seen this is an increased complexity and more specific correlation.

As such the search has returned 9 “hits” that are displayed as video icon images 812 through 844 on the three dimensional surface 740. As such a single video “Roman Holiday” 812 has been displayed for the user in respect of the “Foreign” genre, and two videos “Thirteen” 844 and “Girl next Door” 842 in the “Independent Women” genre. Correlation within this genre being based upon extracting references within the customer review text, rather than simply approval percentages, as the user's genre title is personalized.

Also shown are four videos within the “Action” genre being “Broken Arrow” 822, “Collateral Damage” 824, “Basic” 828, and “007 Mondo Suficiente” 826. In this genre the customer reviews returned “007 Mondo Suficiente” 826 with high customer reviews for the “Action” genre but the correlation application in determining from databases accessed that the film is a foreign language version of “007 The World is Not Enough” and has placed the image associated with this film close to the boundary with the “Foreign” genre search results.

Further, the search has returned two additional films “Aladdin” 832 and “Babe” 834. Whilst these films do not match a primary genre of the user in that they are: “Children's Movies” they have been returned from the search on the basis of having very high customer approval ratings, where for example the user has specified they wish to see films closely related to their search with approval ratings greater than 95%, and elements which match their genre. As such “Aladdin” 832 is actually “Aladdin—Rey de los Ladrones” being the Spanish version of “Aladdin and The King of Thieves” and hence matching the “Foreign” genre aspect of the users search. Similarly, “Babe” 834 was returned due to the high customer approval rating and that customer reviews praised the independent nature of the female lead character in the film.

As presented supra in respect of FIG. 8, the application provides highly correlated database search results and display visualization for titles of videos based upon a correlation between a client database and databases of others, for example customers buying each of several videos who have provided customer reviews. Such a correlation optionally employs, a single database representing a single commercial retailer, multiple databases each relating to a single retailer, or even a single database storing customer preferences and purchase histories independent of any one specific commercial retailer. An example of the later being for example, clients storing these preferences within a provider of services such as Yahoo!™, eBay™, or Google™ where providing this information within a remote database allows the user to access their preferences from any location, such as when they are on vacation, traveling, at work, etc.

As shown within the “Also Like” display 800 the placement of the icon images representing the video icon images 812 through 844 onto the three dimensional surface 740 has been based upon the average time since last viewing of the genre for which icon images 812 through 844 were returned. Similarly, “Aladdin” 832 and “Babe” 834 are placed towards the lower, wider portion of the cone three-dimensional surface 740 as the genre they relate to have high average times since last viewing. Of course, the placement of video icon images 812 through 844 on the three dimensional surface 740 is optionally determined based upon a range of other predetermined criteria. Optionally, the three-dimensional surface 740 employed for presenting the “Also Like” display 800 is different to that displaying the three-dimensional visualization 700 of the users own video collection.

According to another embodiment of the invention the application providing the highly correlated database searching and display visualization is used to provide a user with recommendations of products from a different category than the one for which they have stored database information. The result visualization 900 presented in FIG. 9 being generated by the correlation application in response to a user request to find music CDs, for which they currently have none or very few. As such the correlation application in providing the correlation of documents returned uses user preferences for video genre to categorize music CDs having high averaged customer approval ratings from multiple databases, providing a correlated set based upon weighting the approval ratings from the multiple databases. Of course, when the user has many genres of items within their database, a correlation of all items within all genres assists in more accurately suggesting products. Alternatively, the correlation is limited to the genre in which recommendations are sought after.

As a result the result visualization 900 presents to the user a series of CD image icons 912 through 954 distributed over the three-dimensional visualization surface 740. Of these “Vivaldi—Quattro Stagioni” 912, and “Fasch—Concerto & Symphonia” 914 are placed in a position associated from the three-dimensional visualization 700 of the users' own video collection with the “Foreign” genre. Similarly, “Acoustic Triangle” 932, “Music in the Air” 934 and “Moods” 936 are albums with high approval ratings and associated with single female singer-songwriters and as such “Independent Women”. Of course it is also possible that the musical recommendations do not fit into any similar or analogous categories to the films.

In relation to the “Action” genre category of the users video collection the application has returned four CDs for the user, “Stripped” 924, “Feet” 922, “Let Go” 928, and “Bayou” 926. The correlation application selecting these CDs on the basis that they contain several tracks associated with “Action” movies. In one instance “Let Go” 928 is an album by a well-known female singer-songwriter but the albums ratings overall are lower in the category of “independent women” to that from reviewers having correlating purchases within the “Action” genre. As such this placement optionally provides an indication to the user that this CD has a limited number of tracks matching their interests rather than all tracks.

Alternatively, though the above embodiments are described with reference to known data associated with the displayed elements, it is also possible to organize data based on statistical data derived through analysis, such as with data mining, or derived from users via polling, queries, or community based information. For example, a community providing information such as blogs (World Wide Web logs), music communities, consumer communities, etc. Conveniently, when consumers each provide lists of products they enjoy, it is possible statistically to create a three-dimensional representation of products that are “similar” based on user provided data. Thus, if a user enters one or more products they like, a display of data relating to the one or more products is shown allowing the user to navigate through products that are statistically similar. Then by removing products that are deemed undesirable, the user affects the view to isolate products that are “similar” and acceptable. This, of course, also applies to music, to services, to films, to television broadcasts, and so forth.

As an example, a user may enter that they like Cargo™ jeans, Nike™ trainers and Gap™ sweaters. Based upon correlating these preferences with a variety of databases, including in this example BLOGS of students within the San Francisco Bay area of California and the shopping mall store directories Bayshore and Carlingwood, being two local shopping malls for this 14 yr old female user in Ottawa, Ontario, Canada. Such databases as evident from this example do not have to be limited to those of a single “style” such as store directories, retailer websites, etc. As a result the user is presented with a list of items, including Tristan cardigans, La Senza lingerie, Garage t-shirts, Adidas sunglasses and Adidas “Missy Elliot” shoes. All of these items are not only highly rated by students within the San Francisco Bay area of California but are available from stores within either of the Bayshore and Carlingwood shopping malls. The user could further restrict their search based upon, for example, a single shopping mall, preferred color range of clothing, a size range such as petite, or age range of the bloggers.

According to another embodiment the user may be searching for a provider of a service, such as installing a shower fitting into a property. In this example the user has a database that comprises other items they have purchased and have had installed or are awaiting installation, such as tiles, cabinets, electrical outlets, toilets, kitchen faucets, and flooring. These including the make of the different products. In searching according to the prior art the user is faced with many sources of disparate information, and without recourse to contacting each source does not know whether the source is reliable and experienced with this unusual surround shower fitting imported from Sweden. However, by undertaking the search according to the invention the user is provided with a list of contractors who have high customer approval ratings, and have experience with the high-end products the user is seeking installed. As such at least one embodiment of the invention allows a user to correlate aspects of services and service requirements, in addition to the features relating to products themselves.

Accordingly based upon the embodiments outlined in respect of FIGS. 6 through 9, a user is able to access, correlate, and comprehensibly visualize the immense amount of information currently accessible through the World Wide Web, and increasing substantially every day. Particularly in respect of customer preferences, purchasing decisions, manufacturing planning etc., the ability to correlate in a highly specific manner information from tens, to millions of users of the Internet is a powerful tool that is not currently provided by prior art solutions. Whilst the embodiments presented have been addressed to users that are a single individual, the approach also allows businesses to make decisions based upon obtaining highly correlated data from the World Wide Web using sources they might not normally consider as providing appropriately qualified data. As such individual blogs might not influence a fashion designer, but a correlated result from one million blogs is potentially more influential than a market research firms report.

Though the above embodiments are often described with reference to customer approval ratings, feedback and customer recommendations, the invention is implementable with automated correlation such that queries are solved based on others solutions, good or bad. For example, a CD recommended for a user is selected based on a statistical number of individuals correlating highly in CD collection contents with the user and by selecting a next highly correlated content element that is not within the CD collection of the user. Further this is equally applicable across multiple genres.

Numerous other embodiments may be envisioned without departing from the spirit and scope of the invention.

What is claimed is:

1. A method comprising:
storing first data for each one of a plurality of different users, first data for each user including data relating to at least one of a good, a service, a need, an ability, a responsibility, and an opinion that is associated with that user;
correlating the first data of one user of the plurality of different users with the first data of other users of the plurality of different users to identify which of the other users have first data correlating with the one user's first data to within a predetermined threshold limit so as to define a group of correlated users;
analyzing the first data of each user of the group of correlated users according to a known process, the known process for identifying a similarity in the first data, excluding similarities that match the one user's first data to within the predetermined threshold amount, the identified similarity in the first data indicative of one or more suggestions; and,
providing an indication of at least the first data for presentation to the one user.

2. A method according to claim 1 wherein the first data comprises user consumer-history data.

3. A method according to claim 1 wherein,
providing an indication comprises presenting a three dimensional representation of data relating to the first data having identified similarities to the first data of the one user, the three dimensional representation providing correlative context to the data.

4. A method according to claim 3 wherein,
presenting the three dimensional representation comprises presenting the three dimensional representation in dependence upon a viewpoint of the user with respect to the three dimensional representation.

5. A method according to claim 4 wherein presenting the three dimensional representation comprises varying an amount of information indicated in dependence upon a viewpoint of the user with respect to the three dimensional representation.

6. A method according to claim 1 wherein identifying a similarity comprises providing a score associated with the identified similarity, the score determined in dependence upon the known process and the first data.

7. A method according to claim 6 wherein the score is determined in dependence upon a correlation of all of the first data with all of the first data of other users to determine an overlap, the score indicative of a percentage of the first data of the one first user that correlates with first data of the other users.

8. A method according to claim 6 wherein providing an indication comprises presenting a three dimensional representation of suggestions present within the first data of the other users that correlate with the first data of the one user in dependence upon the score.

9. A method according to claim 8 wherein presenting the three dimensional representation comprises presenting the three dimensional representation in dependence upon a viewpoint of the user with respect to the three dimensional representation.

10. A method according to claim 8 wherein presenting the three dimensional representation comprises varying an amount of information indicated in dependence upon a viewpoint of the user with respect to the three dimensional representation.

11. A method according to claim 1 wherein
the first data relates to skills within a first set of skills of a first entity;
wherein correlating and analyzing comprise determining different a first group of users with skills including a significant number of same skills and determining other skills that are common amongst users of the first group but other than within the first set of skills; and
wherein the indication relates to at least an indicated skills.

12. A method according to claim 11 wherein the indication provides an indication of how many of the first group also have an indicated skill.

13. A method according to claim 11 wherein the indication provides an indication of a correlation between the set of skills and the at least an indicated skill.

14. A method of assessing preference tendencies, comprising:
receiving first data that is associated with a first user;
using a predetermined process, mapping the first data onto a data structure having stored therein other data associated with each one of a plurality of other users;
correlating the first data with the other data to determine a group of other users selected from the plurality of other users, each user within the determined group of other users having first data associated therewith that matches the first data of the first user to within a predetermined threshold limit;
correlating the first data of each user within the determined group of users so as to determine other matches within the group, the other matches relating to a portion of the first data that does not form a part of the first data of the first user, said portion of the first data other than relating to something personal to the first user; and,
providing an indication of the other matches.

15. A method according to claim 14 wherein,
mapping the first data onto a data structure comprises generating the data structure in dependence upon at least an aspect of the first data.

16. A method according to claim 14 wherein,
providing an indication comprises presenting a three dimensional representation of the other matches having identified similarities to the first data of the one user.

17. A method according to claim 16 wherein,
presenting the three dimensional representation comprises presenting the three dimensional representation in dependence upon a viewpoint of the user with respect to the three dimensional representation.

18. A method according to claim 17 wherein,
presenting the three dimensional representation comprises varying an amount of information indicated in dependence upon a viewpoint of the user with respect to the three dimensional representation.

19. A method according to claim 14 wherein,
identifying a similarity comprises providing a score associated with the identified similarity, the score determined in dependence upon the known process and the first data.

20. A method according to claim 19 wherein,
providing an indication comprises providing an indication of the other matches in dependence upon the score.

21. A computer-readable storage medium having stored thereon computer-executable instructions for performing a method of assessing consumer preference tendencies, the method comprising:
storing first data for each one of a plurality of different users, first data for each user including data relating to at least one of a good, a service, a need, an ability, a responsibility, and an opinion that is associated with that user;
correlating the first data of one user of the plurality of different users with the first data of other users of the plurality of different users to identify which of the other users have first data correlating with the one user's first data to within a predetermined threshold limit so as to define a group of correlated users;
analyzing the first data of each user of the group of correlated users according to a known process, the known process for identifying a similarity in the first data, excluding similarities that match the one user's first data to within the predetermined threshold amount, the identified similarity in the first data indicative of one or more suggestions; and,
providing an indication of at least the first data for presentation to the one user.

22. A computer-readable storage medium having stored thereon computer-executable instructions for performing a method of assessing consumer preference tendencies, the method comprising:
receiving first data that is associated with a first user;
using a predetermined process, mapping the first data onto a data structure having stored therein other data associated with each one of a plurality of other users;
correlating the first data with the other data to determine a group of other users selected from the plurality of other users, each user within the determined group of other users having first data associated therewith that matches the first data of the first user to within a predetermined threshold limit;
correlating the first data of each user within the determined group of users so as to determine other matches within the group, the other matches relating to a portion of the first data that does not form a part of the first data of the first user, said portion of the first data other than relating to something personal to the first user; and,
providing an indication of the other matches.
